(19) United States
(12) Patent Application Publication
(10) Pub. No.: US 2010/0162771 A1
(43) Pub. Date: Jul. 1, 2010

(54) METHOD OF FORMING CERAMIC STRINGS AND FIBERS

(75) Inventor: Arden L. Just, Kent, OH (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: ZIRCOA, INC

(21) Appl. No.: 12/346,966

(22) Filed: Dec. 31, 2008

(51) Int. Cl. C03B 37/016

(52) U.S. Cl. 65/440

(57) ABSTRACT

A method of forming a ceramic fiber comprising the steps of forming a slip comprised of water, ceramic powder, and a binding agent; forming a generally continuous stream of the slip; introducing the stream of the slip into a chemical solution at a concentration wherein the binding agent causes the ceramic slip to form a gelled fiber; removing the gelled fiber from the chemical solution; drying the gelled fiber to remove moisture therefrom; and firing the fiber to produce a ceramic.

### FIELD OF THE INVENTION

The present invention relates generally to a method of forming ceramic fibers.

### BACKGROUND OF THE INVENTION

Conventional processes for forming ceramic fibers involve the use of precursors, typically polymers that react with a solvent or catalyst to form a ceramic. The ceramic is formed by a reaction between the precursors and the solvent or catalyst. The chemical precursors are relatively expensive, and such processes require a “burn-out” step to remove the polymer from the desired ceramic material. Such processes also typically include a forming step, such as an extrusion step or a spinning step, to form the actual fiber. If short ceramic fibers are desired, a cutting, i.e., sizing, step may also be required during the forming step or after the polymer “burn-out” step. Because of the cost of the chemical precursors and the numerous processing steps involved, the overall process is relatively expensive and complex.

The present invention provides a novel method of forming a ceramic fiber from a ceramic slip, which process does not require a chemical precursor and does not require a “polymer burn-out” step.

### SUMMARY OF THE INVENTION

In accordance with a preferred embodiment of the present invention, there is provided a method of forming a ceramic fiber comprising the steps of forming a slip comprised of water, ceramic powder, and a binding agent; forming a generally continuous stream of the slip; introducing the stream of the slip into a solution containing calcium chloride (CaCl₂) at a concentration wherein the binding agent causes the ceramic slip to form a gelled fiber; removing the gelled fiber from the calcium chloride (CaCl₂) solution; drying the gelled fiber to remove moisture therefrom; and firing the fiber to produce a ceramic fiber.

The advantage of the present invention is a method of forming ceramic fibers.

Another advantage of the present invention is a method of forming ceramic fibers that does not include a polymer carrier or chemical precursor.

Another advantage of the present invention is a method of forming a ceramic fiber that does not include a “burn-out” step to remove a polymer binder or a chemical precursor from the material.

A still further advantage of the present invention is a method of forming a ceramic fiber that does not include a complex drawing or spinning step to form a fiber.

A still further advantage of the present invention is a method of forming a ceramic fiber from a ceramic slip.

A still further advantage of the present invention is a method of forming a ceramic fiber where the fibers are formed from a simple extrusion process.

A still further advantage of the present invention is a method of forming a ceramic fiber, wherein the properties of the ceramic fiber can be more accurately controlled by controlling the properties of a ceramic slip.

A still further advantage of the present invention is a method of forming a ceramic shape.

Another advantage of the present invention is a method of forming a porous ceramic shape.

These and other advantages will become apparent from the following description of a preferred embodiment.

### DETAILED DESCRIPTION OF PREFERRED EMBODIMENT

The present invention relates to a method of forming a ceramic shape such as a ceramic fiber. In accordance with one aspect of the present invention, a ceramic fiber is formed from a ceramic slip using a sol-gel process.

Broadly stated, in accordance with the present invention, a ceramic fiber is formed by:

(a) forming a slip comprised of water, a binding agent, and about 20% to about 80% by weight of a ceramic powder, the ceramic powder having a particle size less than 42 microns (μm) and the slip having a viscosity of about 150 to 3,500 centipoise,

(b) forming a continuous stream of the slip by forcing the slip through an orifice into a chemical solution having a concentration wherein the stream of said slip gels into a fiber,

(c) drying the fiber to remove moisture therefrom, and

(d) firing the fiber at a temperature sufficient to sinter the ceramic.

More specifically, a ceramic slip is formed from a mixture of water and ceramic powder. The slip is preferably comprised of water and between 20% and 80% ceramic solids. The ceramic powder may be comprised of a single ceramic material or a mixture of two or more different ceramic materials. The ceramic powder has a particle size such that ninety percent (90%) of the ceramic powder has a particle size less than 42 microns (μm). Preferably, ninety percent (90%) of the ceramic powder in the ceramic slip has a particle size between 42 microns (μm) and 0.6 micron (μm).

In accordance with one embodiment of the invention, a slip is formed of ceramic powder and water, and the ceramic slip is milled to reach the desired particle size.

The ceramic slip is formed to have a viscosity between about 100 centipoise and 3,500 centipoise.

In accordance with one embodiment of the process, the ceramic powder in the slip is milled until approximately 90% of the particles within the ceramic material have a diameter of about 0.40 microns (μm) to about 0.45 microns (μm).

Depending upon the ceramic system being processed, it may be desirable to add a sintering aid to the ceramic slip. As will be appreciated by those skilled in the art, the sintering aid, and the amount thereof, will be determined by the ceramic system being processed. By way of example and not limitation, a sintering aid in the form of a dry powder may be added to the slip in a concentration range of about 0.1% to about 1% by weight, i.e., based upon the final weight of the ceramic material.

In one embodiment, the ceramic and water slip are then further milled until the average particle diameter of the ceramic slip is about 0.43 microns (μm). The water composition of the final mixture is preferably between about 20% to about 80% by weight.

A binding agent is then added to the final slip mixture to form a “sol.” The binding agent is added such that the binding agent has a concentration of about 0.7% to about 1.4% by weight. The binding agent may be comprised of various ammonia-based and/or sodium-based alginates. In accordance with one embodiment of the present invention, an ammonia-based alginate, sold under the trade name of Collatex™, is added to the slip mixture.

The ceramic fibers are formed by forcing the aforementioned “sol” through an orifice to form a thin stream of the slip, and then introducing the stream of slip into a chemical solution that is operable to cause gelling of the slip. As will be appreciated by those skilled in the art, different chemical solutions may be used to gel the ceramic slip containing an ammonia-based and/or sodium-based alginate.

In one embodiment of the present invention, a calcium chloride (CaCl₂) solution is used. The calcium chloride (CaCl₂) solution is comprised of water and about 7% to about 12% calcium chloride. The calcium chloride (CaCl₂) solution has a temperature of about 60° F. (15.5° C.) to about 140° F. (60° C.). In accordance with one aspect of the present invention, the calcium chloride (CaCl₂) solution is agitated to produce high shear forces in the solution.

As the stream of slip enters the chemical solution, a chemical reaction occurs between the alginate binder in the slip and the chemical solution. As a result, the stream of the slip begins to solidify in the chemical solution, as in a conventional sol-gel process. In addition, the high shear force in the solution breaks the gelled stream of ceramic slip into shorter strands, i.e., fibers, of the gelled slip.

Depending upon the composition of the slip, the strands, i.e., fibers, of ceramic remain in the chemical solution for a period of time sufficient to fully gel the ceramic strands. For a ceramic slip containing an ammonia-based or sodium-based alginate and a chemical solution containing calcium chloride (CaCl₂), the ceramic fibers may remain within the calcium chloride (CaCl₂) solution for between 5 minutes and 60 minutes until the strands of slip are fully gelled.

Depending upon the chemicals used in the chemical solution that gels the ceramic slip, it may be desirable to wash the resultant gelled fiber to remove residual chemicals within the fibers and to reduce the chemical content of the gelled fibers. By way of example and not limitation, if a calcium chloride solution is used to gel the ceramic slip, the fibers are preferably washed until the calcium chloride content of the fibers is between about 0.01% and about 0.8% by weight relative to the weight of the metal oxides within the fibers.

The resultant fibers are then dried to remove moisture therefrom. The ceramic fibers are heated sufficiently to dry the ceramic fibers. By way of example and not limitation, the ceramic fibers may be heated to a temperature between about 105° C. and about 150° C. for about two hours to about sixteen hours. The dried fibers are then fired at an appropriate temperature sufficient to sinter the ceramic fibers. For zirconia compositions, the ceramic fiber are heated to a temperature between about 1,320° C. and about 1,700° C. for about two hours to about eight hours to produce ceramic fibers.

Factors that affect the resulting ceramic fibers include the composition of the ceramic slip, the rheology of the slip, the flow rate, i.e., the feed rate, of the slip into the chemical solution and the type and shape of the orifice through which the slip is forced.

The invention shall now be further described with regard to the following example that relates to the formation of magnesium-zirconium oxide fibers according to the foregoing method.

### EXAMPLE

A ceramic slip is formed of water and magnesium-zirconium oxide. Ninety percent (90%) of the magnesium-zirconium oxide in the ceramic slip has a particle size less than 43 microns (μm). The magnesium-zirconium oxide comprises about 50% by weight of the ceramic slip. The ceramic slip includes about 0.7% by weight to about 1.4% by weight of an alginate binder. The ceramic slip has a viscosity of about 150 cps.

The ceramic slip is forced through a 20-gauge circular opening located above a tank containing a calcium chloride (CaCl₂) solution containing about 9% calcium chloride. The calcium chloride (CaCl₂) solution has a temperature of about 70° F. (21.1° C.).

The ceramic slip exiting the orifice forms a continuous, string-like stream that enters the calcium chloride (CaCl₂) solution. The slip begins to gel once in contact with the calcium chloride (CaCl₂) solution. The calcium chloride (CaCl₂) solution in the tank is agitated to form high shear forces in the calcium chloride (CaCl₂) solution. The turbulence of the calcium chloride (CaCl₂) solution causes the stream of ceramic slip to form strands of fibers that are quickly gelled. The gelled fibers settle along the bottom of the tank. The gelled fibers remain in the calcium chloride (CaCl₂) solution for about 15 minutes or until filly gelled. The resultant fibers have an average length of about 800 microns and a diameter of about 200 microns.

The ceramic fibers arc removed from the calcium chloride (CaCl₂) solution and washed until the calcium chloride content of the fibers is about 0.4% by weight.

The fibers arc then dried at a temperature of about 105° C. for about 20 minutes to about two hours.

The dried fibers are fired at a temperature of about 1,600° C. for about four hours to produce magnesium-zirconium-oxide-ceramic fibers.

The resultant ceramic fibers exhibit the following physical properties:

Range of properties:
Diameter 10 microns to about 3 mm
Aspect ratio from 3 to 1 and about 30 to 1
Loose bulk density 3.35 g/cm³ to about 1.3 g/cm³

The present invention thus provides a method of forming ceramic fibers from a ceramic slip using a sol-gel process. The foregoing process further allows formation of fibers from different ceramic powders.

In accordance with another aspect of the present invention, the foregoing process may be used to form porous shapes that are comprised of one or more elongated ceramic fibers. In the aforementioned process, fibers were formed by introducing a string-like stream of ceramic slip into an agitated chemical solution. A porous ceramic shape may be formed by positioning a mold within a calm, un-agitated chemical solution and by directing a stream of the ceramic slip into the chemical solution above the mold. Once in contact with the chemical solution, the alginate in the slip gels the slip into a continuous fiber or string that is still flexible. The gelled string or fiber is collected in the mold, fills the mold, and assumes the shape of the mold, as the fiber overlays onto itself in the mold. The gelled fiber maintains its fiber shape as it fills the mold. Passages and openings are defined between overlaying portions of the fiber(s). As a result of these passages and openings, the overall ceramic shape is porous.

In accordance with another aspect of the present invention, the gelled string or fiber are collected on a moving surface within the chemical solution. The moving surface may be defined by a moving platform or a continuously moving surface, such as, by way of example and not limitation, a conveyor belt.

In accordance with another aspect of the present invention, the porosity of the ceramic shape may be varied by adding a foaming agent, such as, by way of example and not limitation, a two part foaming agent to the refractory slip. A foaming agent in the ceramic slip causes the string-like stream of ceramic slip to swell and foam once it exits the forming orifice into the chemical solution that gels the slip. By adding a foaming agent to the ceramic slip prior to the gelling process, a less-dense, lighter ceramic shape may be formed, having varying degrees of porosity.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A method of forming a ceramic fiber, comprising the steps of:
forming a slip comprised of water, ceramic powder, and a binding agent;
forming a generally continuous stream of said slip;
introducing said stream of slip into a chemical solution at a concentration wherein said binding agent causes said ceramic slip to form a gelled fiber;
removing said gelled fiber from said chemical solution;
drying said gelled fiber to remove moisture therefrom; and
firing said fiber to produce a ceramic.

2. A method as defined in claim 1, wherein said slip is comprised of 20% to 80% ceramic particles.

3. A method as defined in claim 2, wherein about 90% of said ceramic powder has a particle size less than 42 microns (μm).

4. A method as defined in claim 2, wherein said slip has a viscosity of between 150 centipoise and 3,500 centipoise.

5. A method as defined in claim 1, wherein said binding agent is an alginate.

6. A method as defined in claim 5, wherein said binding agent is an ammonia-based alginate.

7. A method as defined in claim 5, wherein said binding agent is a sodium-based alginate.

8. A method as defined in claim 5, wherein said chemical solution is comprised of calcium chloride (CaCl₂).

9. A method as defined in claim 1, further comprising:
washing said gelled fiber to reduce the chemical content of said gelled fiber, said washing step being prior to said drying step.

10. A method as defined in claim 9, wherein said chemical solution is comprised of calcium chloride (CaCl₂).

11. A method as defined in claim 10, wherein said gelled fiber is washed until the calcium chloride content of said fibers is between about 0.01% and about 0.8% by weight.

12. A method as defined in claim 1, wherein said drying step comprises exposing said gelled fiber to a temperature between about 105° C. and about 150° C. for between two hours and sixteen hours.

13. A method as defined in claim 1, wherein said firing step comprises exposing said gelled fiber to a temperature between about 1,300° C. and 1,700° C. for between two hours and six hours.

14. A method as defined in claim 1, wherein said calcium chloride (CaCl₂) solution is agitated when said slip is introduced thereinto.

15. A method as defined in claim 1, wherein said chemical solution is comprised of a calcium chloride (CaCl₂) solution that contains about 7% to about 12% by weight calcium chloride (CaCl₂).

16. A method as defined in claim 15, wherein said calcium chloride (CaCl₂) solution has a temperature between 60° F. (15.5° C.) and 140° F. (60° C.).

17. A method as defined in claim 1, wherein said gelled fiber is collected in a mold in said calcium chloride (CaCl₂) solution until said gelled fiber fills said mold and forms a shape conforming to said mold.

18. A method as defined in claim 2, wherein said ceramic slip includes a foaming agent.

19. A method as defined in claim 1, wherein said gelled fiber is collected on a moving surface within said chemical solution.
